(19) United States
(12) Patent Application Publication
(10) Pub. No.: US 2011/0263466 A1
(43) Pub. Date: Oct. 27, 2011

(54) Method of Simultaneously Dissolving Calcium Carbonate, Silica, and Silicate Minerals in Subterranean Formations

(76) Inventor: Peter Rose, Salt Lake City, UT (US)

(21) Appl. No.: 13/124,383

(22) PCT Filed: Oct. 14, 2009
(86) PCT No.: PCT/US09/60660

§ 371 Date: Jul. 8, 2011

Related U.S. Application Data
(60) Provisional application No. 61/105,694, filed on Oct. 15, 2008.

(51) Int. Cl. C09K 8/528

(52) U.S. Cl. 507/241

(57) ABSTRACT

A method of dissolving minerals in subterranean formations is set forth. The method includes injecting a chelating solution into a subterranean formation. The chelating solution includes a thermally stable chelating agent and sufficient caustic to elevate the pH to 10-12.5. The chelating solution is capable of simultaneously dissolving silica, silicates, and calcite present in the subterranean formation.

### FIELD OF THE INVENTION

The present invention relates generally to methods of dissolving calcium carbonate, silica, and silicate minerals in subterranean formations, such as geothermal and hydrocarbon wells. As such, the present invention relates generally to the fields of geochemistry, chemical engineering, and mineralogy.

### BACKGROUND

Subterranean wellbores have many applications including hydrocarbon (e.g. oil, natural gas, etc.) extraction as well as for use as geothermal wells (e.g. heat exchange, energy production, etc). The flow of fluids into or out of the subterranean media is governed, in part, by the size and permeability of the flow patch, which is itself governed by the porosity of the subterranean formation including inherent porosity and fractures. In order to increase the permeability of the subterranean formation in subterranean wellbores, it is advantageous to remove mineral deposits present in the subterranean formation. One method of doing so is by injecting strong mineral acids. Such methodology has several drawbacks including the deleterious nature of the strong acids on the steel tubular used in the wellbores, the uneven effectiveness of the acid in the wellbore, the potential negative environmental impact of the acids, the increased handling hazards, as well as the high cost associated with the use of the strong acids.

Another method which is used to remove minerals from wellbores is by using a caustic aqueous solution. Unfortunately, the high pH conditions which promote the dissolution of silica/silicate also promote the precipitation of calcite. Accordingly, research continues in an effort to discover safe cost effective methods for effective increase in fluid flow through subterranean wellbores.

### SUMMARY

An effective method for the simultaneous removal of silica, silicate and calcium carbonate minerals from subterranean formations is provided. The method includes the step of injecting a caustic solution containing a thermally stable chelating agent into the subterranean geothermal formation in need of mineral removal. The chelating solution is formulated to simultaneously dissolve silica, silicates, and calcite which are present in the subterranean formation. The chelating composition can include about 10 wt % to 50 wt % of a thermally stable chelating agent and water at a pH of about 9 to about 13. Additional components, additives, and/or materials can be included in the chelating solutions.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 shows a plot of silica/silicate dissolution in the presence of calcite at a temperature of from 160° C. to 280° C. Each point on the curve shows the mass of silica or silicate dissolved divided by the initial mass and the total solution volume that flowed through the reactor during the experiment.

FIG. 2 shows a plot of calcite dissolution in the presence of silica/silicate at a temperature of from 160° C. to 280° C. Each point on the curve shows the mass of calcite dissolved divided by the initial mass and the total solution volume that flowed through the reactor during the experiment.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present invention, the following terminology will be used in accordance with the definitions set forth below.

It is noted that, as used herein, the singular forms of “a,” “an,” and “the” include plural referents unless the context clearly dictates otherwise. Thus, for example, reference to “a thermally stable chelating agent” includes one or more of such chelating agents, reference to “wellbore” includes reference to one or more of such structures, and reference to “injecting” includes reference to one or more of such steps.

### DEFINITIONS

As used herein, the term “thermally stable chelating agent” refers to a chelating agent which is chemically stable at high temperatures, i.e. does not degrade or breakdown upon exposure to conditions of elevated temperatures and pressures.

Also as used herein, “high temperature” typically covers the range from 150° C. to 330° C. Some chelating agents are thermally stable, and therefore useful, at lower temperatures, but decompose upon exposure to higher temperatures. For example, the chelating agent ethylenediaminetetracetic acid (EDTA) has a half-life of about 1 hour at 200° C., meaning that after one hour at 200° C., the concentration of EDTA in solution will be reduced by 50%. In contrast, the chelating agent nitrilotriacetate (NTA) has a half life of about 1 hour at 290° C. Thus, as there exists a range of reservoir temperatures, it will be necessary to select an appropriate chelating agent for each thermal environment.

As used herein, the term “thermally stable chelating agent” refers to a chelating agent that is sufficiently thermally stable not to decompose at the reservoir temperature of interest. Thus, EDTA would be a thermally stable chelating agent at a reservoir temperature of 190° C., but not at 290° C. In contrast, NTA would be a thermally stable chelating agent for all temperatures up to and including 280° C. Non-limiting examples of thermally stable chelating agents include ethylenediaminetetraacetic acid (EDTA). hydroxyethylenediaminetetraacetic acid (HEDTA), nitrilotriacetate (NTA), hydroxyaminocarboxylate (HACA), hydroxyethyliminodiacetate (HEIDA), phthalate (e.g, salt of phthalic acid such as disodium, dipotassium, calcium etc.), and citrate (e.g. salt of citric acid) and mixtures thereof.

As used herein, the terms “simultaneous” or “simultaneously” when used in connection with the dissolution or dissolving of silica, silicates, and calcites, by a chelating solution at high pH, refers to the ability of the chelating solution to dissolve and maintain silica, silicate, and calcite minerals in solution at the same time, e.g. at least 5% solubility per mineral. Simultaneous dissolution does not require that the chelating agent actually dissolve the minerals at the same moment in time, but rather that the chelating solution be capable of dissolving each of the silica, silicate, and calcite minerals and maintaining them in a common solution simultaneously.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub ranges such as from 1-3, from 2-4, and from 3-5, etc. This same principle applies to ranges reciting only one numerical value. Furthermore, such an interpretation should apply regardless of the breadth of the range or the characteristics being described.

In the present disclosure, any steps recited in any method or process claims may be executed in any order and are not limited to the order presented in the claims, Means-plus-function or step-plus-function limitations will only be employed where for a specific claim limitation alt of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### EXEMPLARY EMBODIMENTS

Chelating solutions and related methods for dissolving minerals in subterranean formation are provided. The chelating solution of the present invention can be capable of simultaneously dissolving silica, silicate, and calcite minerals present in subterranean formations. The chelating solution can include a thermally stable chelating agent and water at a pH from 9 to 13. The chelating solution can be used to dissolve minerals present in the subterranean formation by injecting the chelating solution into the subterranean formation.

The chelating solution can use any thermally stable chelating agent known in the art, in particular those chelating agents which are known to be effective in aiding solubilization of silica, silicate, and calcite minerals. Non-limiting examples of thermally stable chelating agents include ethylenediaminetetraacetic acid (EDTA), hydroxyethylenediaminetetraacetic acid (HEDTA), nitrilotriacetate (NTA), hydroxyaminocarboxylate (HACA), hydroxyethyliminodiacetate (HEIDA), phthalate, and citrate and mixtures thereof. In one embodiment, the thermally stable chelating agent includes nitrilotriacetate. in another embodiment the nitrilotriacetate comprises 15 wt % to 25 wt % of the chelating solution in the pH range 9-13.

The thermally stable chelating agents and base (e.g. NaOH) can be present in the chelating solution in any amount so long as there is adequate thermally stable chelating agent and base to provide effective dissolution of the targeted minerals. As costs associated with the transport and use of the chelating solution can be relatively high, in some embodiments it can be desirable to use chelating solutions which are at or near their saturation point with respect to the thermally stable chelating agent. Generally, the saturation point of each of the thermally stable chelating agents can be determined by one of ordinary skill in the art and will likely vary depending on the pH, temperature, or chemical makeup of the chelating solution. In one embodiment, the thermally stable chelating agent can comprise about 10% to 50 wt % of the chelating solution. In another embodiment, the thermally stable chelating agents can comprise about 15 wt % to about 40 wt % of the chelating solution. However, other concentrations may be suitable depending on the particular chelating agent and conditions used.

The chelating solutions of the present invention can be aqueous solutions which have basic pH values, In one embodiment, the chelating solution can have a pH of about 10 to about 12.5. In another embodiment, the chelating solution can have a pH of about 11 to about 12.2. The relatively high pH values help promote the dissolution of the silica and silicate minerals and are less hazardous and are more environmentally friendly. However, solutions at high pH values without a chelating agent can cause the precipitation of carbonate minerals. The combination of the chelating agent and high pH can allow for the simultaneous dissolution of carbonate minerals (e.g., calcite) and silica/silicate minerals respectively.

The chelating solution can optionally include sodium citrate. Although concentrations can vary, the sodium citrate generally can be present in the chelating solution in an amount of 10 wt % to about 50 wt % of the total chelating solution. In another embodiment, the sodium citrate can comprise about 15 wt % to about 45 wt %. Actual concentrations of each of the sodium citrate and thermally stable chelating agents can vary depending on the specific compounds, formation temperatures and pressures, desired reaction times, residence times, type of formation, and the like. For example, sodium citrate is generally thermally stable only up to about 175° C.

The chelating solutions of the present invention can be injected into any type of subterranean formation. Specific applications include wellbores for geothermal wells as well as hydrocarbon (oil, gas, etc.) wells. Suitable subterranean formations can typically include geothermal formations. In particular, the kinetics of dissolution of silica/silicate minerals are slow at low temperatures. Since the temperatures of hydrocarbon reservoirs are generally less than 200° C., the present invention is generally more effective for dissolving silica/silicates in higher temperature geothermal formations. The injection can be done using any method known in the art including, but not limited to, bull-heading or spotting using coiled tubing. In the latter method, a small diameter tube (generally less than 2″ in diameter) is deployed down the wellbore and the reagent solution is injected through the tubing. This allows for the placement of the reagent only at the target treatment zone.

After injection, the chelating solution is maintained in the subterranean formation for a period of time sufficient to dissolve a desired amount of the minerals. The length of the residence time of the chelating solution in the subterranean formation will vary depending on several factors including, among others, the desired porosity of the subterranean formation, the amount of minerals in the subterranean formation, temperature and pressure, and the concentration of the chelating solution, In one embodiment, the chelating solution is maintained in the subterranean formation for a length of time of about 2 hours to 5 days.

After the chelating solution is maintained in the subterranean formation for the desired residence time, the chelating solution can be removed or displaced. In one aspect of the invention, the chelating solution can be extracted or pumped out of the subterranean formation. In another embodiment, the chelating solution can be pumped into a separate or deeper area of the subterranean formation. After removal or displacement of the chelating solution, in some embodiments it can be desirable to repeat the injection step by injecting a new or fresh batch of chelating solution into the subterranean formation. Such an extraction and injection cycle could be repeated multiple times if necessary.

### EXAMPLES

### Example 1

### Dissolution of Silica/Silicate in the Presence of Calcite

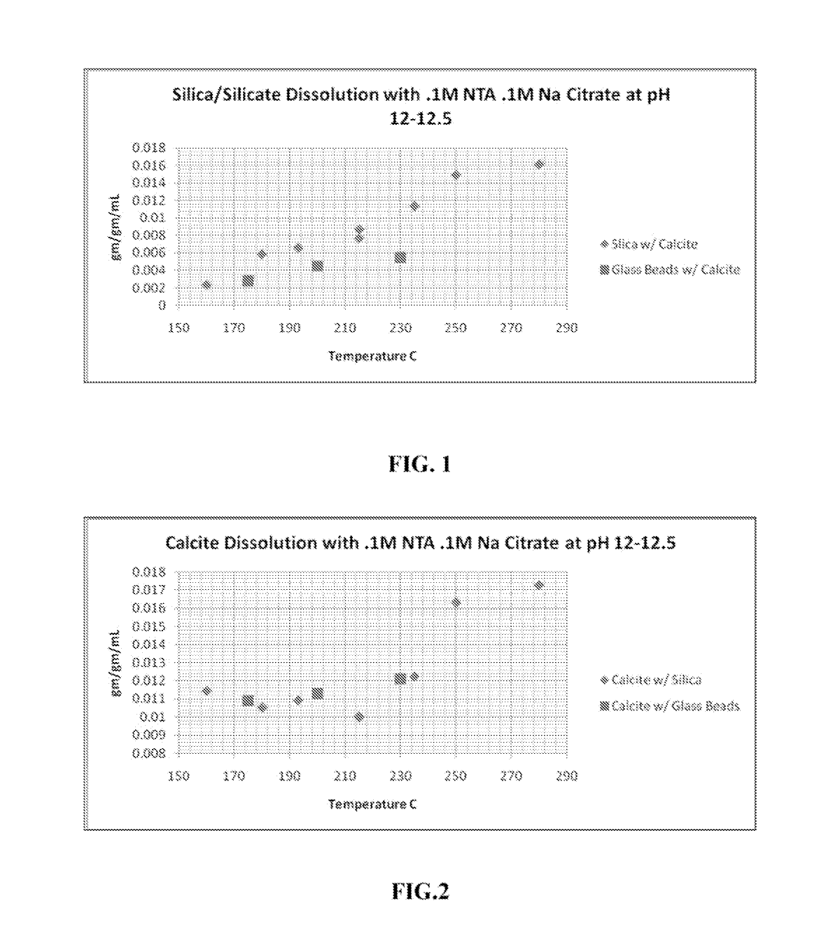

Silica and sodium-aluminum-calcium silicate (glass beads) were alternately placed in a high-temperature flow reactor into which calcium carbonate particles were also placed. Then a solution containing 0.1 M nitrilotriacetate and 0.1 M sodium citrate having a pH between 12-12.5 was flowed through the reactor as it was heated to several temperature points between 160° C. and 280° C. The mass of the silica or silicate dissolved in the solution was measured. As shown in FIG. 1 (a plot of silica or silicate dissolved divided by the initial mass and the total solution volume) the silica or silicate were each dissolved into solution, with increased dissolution at higher temperatures. Although it is evident that silica was dissolving at a greater rate than silicate, it is noteworthy that no attempt was made to control for surface area. Therefore, differences in dissolution rate could be explained, at least in part, by differences in surface area and porosity between the silica and silicate-mineral samples.

### Example 2

### Dissolution of Calcite Silica/Silicate in the Presence of Silica/Silicate

In like manner to Example 1, the reaction was repeated at several temperature points between 160° C. and 280° C., with the calcium carbonate dissolved being measured. As shown in FIG. 2 (a plot of calcite dissolved divided by the initial mass and the total solution volume), the calcite dissolves in the presence of silica/silicate in a nitrilotriacetate solution at high pH and high temperature. Such conditions of high pH normally promote calcite precipitation, but in the presence of the chelating agent and the sodium citrate, there is a net dissolution of calcite. Thus, the combination of NTA and high pH can serve as a viable dissolution agent for dissolving both silica/silicate (previous example) and calcite (this example). This mixture of reagents provides an affordable alternative to the use of hydrofluoric acid for dissolving silica/silicate in wellbores and in near-wellbore formations.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method of dissolving minerals in subterranean geothermal formation, comprising, injecting a chelating solution into the subterranean formation, said chelating solution comprising a thermally stable chelating agent and sufficient caustic to elevate the pH to 9-13, wherein the chelating solution simultaneously dissolves silica, silicates, and calcite in the subterranean formation.

2. The method of claim 1, wherein the thermally stable chelating agent is selected from the group consisting of ethylenediaminetetraacetic acid (EDTA), hydroxyethylenediaminetetraacetic acid (HEDTA), nitrilolriacetate (NTA), hydroxyaminocarboxylate (HACA), hydroxyethyliminodiacetate (HEIDA), phthalate, and citrate and mixtures thereof.

3. The method of claim 1, wherein the thermally stable chelating agent is nitrilotriacetate.

4. The method of claim 1, wherein the thermally stable chelating agent is phthalate.

5. The method of claim 1, wherein the chelating solution has a pH from about 10 to about 12.5.

6. The method of claim 1, wherein the thermally stable chelating agent comprises from 10 wt % to 50 wt % of the chelating solution.

7. The method of claim 1, wherein the thermally stable chelating agent further includes sodium citrate which comprises from 10 wt % to 50 wt % of the chelating solution.

8. The method of claim 1, wherein the thermally stable chelating agent is nitrilotriacetate and comprises about 15-25 wt % of the chelating solution.

9. The method of claim 1, wherein the chelating solution is maintained in the subterranean formation for a length of time of 2 hours to 5 days.

10. The method of claim 9, wherein after the length of time the chelating solution is extracted from the subterranean formation or pumped deeper into the subterranean formation.

11. The method of claim 10, wherein the step of injecting is repeated after the chelating solution is extracted from or pumped deeper into the subterranean formation.

12. The method of claim 1, wherein the injection of the chelating solution is done by bull-heading or by spotting with coiled tubing.

13. A chelating solution for use in dissolving silica, silicates, and calcite in subterranean formation, said chelating solution, comprising:
about 10 wt % to 50 wt % of a thermally stable chelating agent; and water,
wherein the chelating solution has a pH of about 10 to about 12.5.

14. The chelating solution of claim 13, wherein the thermally stable chelating agent is selected from the group consisting of: ethylenediaminetetraacetic acid (EDTA), hydroxyethylenediaminetetraacetic acid (HEDTA), nitrilotriacetate (NTA), hydroxyaminocarboxylate (HACA), hydroxyethyliminodiacetate (HEIDA), phthalate, and citrate and mixtures thereof.

15. The chelating solution of claim 13, wherein the chelating solution has a pH of about 10 to about 12.5.

16. The chelating solution of claim 13, wherein the thermally stable chelating agent comprises from 15 wt % to 40 wt % of the chelating solution.

17. The chelating solution of claim 13, wherein the chelating solution further includes sodium citrate which comprises from 15 wt % to 45 wt %.
